(19) United States
(12) Patent Application Publication
(10) Pub. No.: US 2008/0034998 A1
(43) Pub. Date: Feb. 14, 2008

(54) METHOD OF MAKING A PRINTING BLANKET OR SLEEVE INCLUDING CAST POLYURETHANE LAYERS

(76) Inventors: Joseph L. Byers, Inman, SC (US); W. Toriran Flint, Asheville, NC (US); Samuel R. Shuman, Belgrade, MT (US)

Correspondence Address: DINSMORE & SHOHL LLP, ONE DAYTON CENTRE, ONE SOUTH MAIN STREET, SUITE 1300, DAYTON, OH, 45402-2023, US

(21) Appl. No.: 11/834,870

(22) Filed: Aug. 7, 2007

Related U.S. Application Data
(60) Provisional application No. 60/836,218, filed on Aug. 8, 2006.

(51) Int. Cl. B41F 7/02; B05D 3/02

(52) U.S. Cl. 101/376; 427/385.5

(57) ABSTRACT

A method of making a printing blanket or printing sleeve which includes one or more cast polyurethane layers is provided. Each cast polyurethane layer may be applied in a single pass to a moving substrate web or a rotating sleeve by slot die coating, electrostatic or non-electrostatic spraying, or knife coating. The method may utilize UV or radiation curable polyurethanes, two-part polyurethanes, moisture curable polyurethanes, or cure-blocked or delayed-cure polyurethanes.

### CROSS-REFERENCE TO RELATED APPLICATIONS

This application claims the benefit of U.S. Provisional Application No. 60/836,218, filed Aug. 8, 2006, entitled METHOD OF MAKING A PRINTING BLANKET OR SLEEVE INCLUDING CAST POLYURETHANE LAYERS. The entire contents of said application are hereby incorporated by reference.

### BACKGROUND OF THE INVENTION

The present invention relates to a method of making a printing blanket or printing sleeve, and more particularly, to a method of making a printing blanket/sleeve which includes one or more cast polyurethane layers.

One of the most common commercial printing processes is offset lithography. In this printing process, ink is offset from a printing plate to a rubber-surfaced printing blanket mounted on a blanket cylinder before being transferred to a substrate, such as paper. Typically, the printing blanket is reinforced with a number of fabric and/or polymeric plies.

In recent years, the use of cast polyurethane compounds has been proposed as a partial replacement for the various polymeric and fabric plies typically included in a printing blanket. The use of cast polyurethane compounds is a desirable replacement for such layers as the polyurethane can be applied efficiently, often in a single pass without the need for solvents, and curing can be accomplished in-line at relatively high speeds. Currently, two-part polyurethane systems are known such as those used in rotary casting and other cast elastomer applications in which polyurethanes are dispensed directly into open or closed molds. However, while such systems cure within minutes of mixing, their relatively short pot life makes processing difficult.

A rotary casting method can be used to produce cylindrical blankets or sleeves by depositing a bead of mixed polyurethane on a rotating cylinder in a spiral manner. However, this method results in an uneven gauge (thickness), and the coating must be over-deposited so that it can be subsequently machined to the desired gauge tolerance.

A more preferred method has been the use of knife coating, both in cylindrical and web form, to provide a consistent, metered layer which can often be applied in a single pass. Such coating operations have been commonly used in flat blanket manufacturing and are easily adaptable to cylindrical blanket building. However, the short pot life of two-part castable polyurethane compounds can cause a build-up of cured polyurethane compounds on the coating knife. Such build-up adversely affects gauge control and makes equipment clean up difficult. Two-part castable polyurethanes are available with an extended pot life, but use of such polyurethanes necessitates excessively long and impractical cure times.

A slot die method is also known in which the two-part polyurethane is pumped through a slot so that the rolling bank of material in front of the blade is eliminated. However, in this method, the polyurethane is not completely refreshed along the inner walls of the slot die blade so that a gradual build-up of cured polyurethane still occurs and may occlude the die opening. This results in uneven or blocked flow of the polyurethane. While moisture curable polyurethanes could be used in this type of coating process so that curing does not begin until the polyurethane has exited the slot die blade and is exposed to the atmosphere, preventing premature exposure to moisture requires extreme care both in handling of the polyurethane and in the design of the pumping, mixing, and dispensing equipment.

Accordingly, there is still a need in the art for an efficient method of making an image transfer product such as a printing blanket or sleeve in which one or more cast polyurethane layers may be applied in as little as a single pass without the drawbacks of prior methods.

### SUMMARY OF THE INVENTION

Embodiments of the present invention meet that need by providing methods of making an image transfer product such as an offset printing blanket or sleeve in a single pass using one or more cast polyurethane layers which are applied by slot die coating, electrostatic or non-electrostatic spraying, or knife coating. The method may utilize UV or radiation curable polyurethanes, two-part polyurethanes, moisture curable polyurethanes, or cure-blocked or delayed-cure polyurethanes.

According to one aspect of the present invention, a method of making a printing blanket including a cast polyurethane layer is provided comprising providing a slot die including an inlet, an outlet, and a device thereon for controlling the thickness of the polyurethane layer; introducing uncured polyurethane in the form of a flowable material into the inlet of the slot die, and causing the polyurethane to exit the outlet of the slot die and deposit over substantially the entire surface of a moving substrate web or rotating sleeve to form a layer thereon. The substrate or sleeve with the polyurethane layer thereon is then transported downstream from the slot die where the polyurethane layer is cured.

In this method, the polyurethane layer is formed on the substrate or sleeve in a single pass. By “single pass,” it is meant that the layer is applied in a single step, i.e., the substrate or sleeve does not have to be subjected to separate coating steps and the coating may be achieved by either a single lateral movement or a single rotation.

In this embodiment, the polyurethane is preferably a UV curable polyurethane, a radiation curable polyurethane, a cure-blocked polyurethane, or a delayed-cure polyurethane. By “cure-blocked” and/or “delayed-cure”, it is meant that the polyurethane cure system is not active until a chemical decomposition occurs, which decomposition usually occurs in the presence of heat. Curing is preferably initiated by exposure to a curing source comprising UV light, an electron beam, or a heat source. The curing source is isolated from the slot die such that the polyurethane is not exposed to the curing source as it exits the slot die.

Where the polyurethane is deposited onto a moving substrate web, the substrate web may comprise the base layer of a printing blanket construction. The substrate web may be comprised of a woven or non-woven fabric, or a polymeric material.

In an alternative embodiment where the polyurethane is deposited onto a rotating sleeve, the sleeve is supported on a cylindrical mandrel, and the mandrel is rotated such that the polyurethane is applied to substantially the entire surface of the sleeve to form a seamless layer of material.

The method may also include applying one or more additional polyurethane layers from the slot die onto the moving substrate or rotating sleeve. An example of a printing blanket formed by the method of the present invention may comprise a printing surface layer, a reinforcing layer, a compressible layer, and a base layer.

According to another embodiment of the invention, a method of making a printing blanket or sleeve including a cast polyurethane layer is provided comprising providing a moving substrate web or rotating sleeve; providing a source of uncured polyurethane in liquid form; and electrostatically or non-electrostatically spraying the polyurethane over substantially the entire surface of the moving substrate web or rotating sleeve to form a layer thereon. The polyurethane layer on the substrate or sleeve is then transported downstream from the area of spraying and cured. In this embodiment, the polyurethane layer is also applied in a single pass.

The polyurethane is preferably sprayed in liquid form through a spray nozzle onto the substrate web or sleeve. In this embodiment of the invention, the polyurethane comprises a two-part polyurethane or a moisture curable polyurethane.

The method may further include applying one or more additional polyurethane layers to the moving substrate or rotating sleeve by spraying as described above. An example of a printing blanket construction formed by this method comprises a printing surface layer, a reinforcing layer, a compressible layer, and a base layer.

In yet another embodiment of the invention, a method of making a printing blanket or sleeve including a cast polyurethane layer is provided comprising providing uncured polyurethane in flowable form from a source; coating the polyurethane onto a moving substrate web or rotating sleeve using a coating apparatus comprising a knife blade to control the thickness of the applied coating of polyurethane; and transporting the polyurethane coated substrate or sleeve downstream from the coating apparatus and curing the polyurethane. In this embodiment, the polyurethane is also applied in a single pass.

In this embodiment, the polyurethane source preferably comprises a rolling bank of uncured polyurethane. The polyurethane is preferably a UV curable polyurethane, a radiation curable polyurethane, a cure-blocked polyurethane, or a delayed-cure polyurethane. The curing is initiated by a curing source comprising UV light, electron beam or heat. The curing source is isolated from the coating apparatus such that the rolling bank of uncured polyurethane is not exposed to the curing source.

In an alternative embodiment of this method, the polyurethane comprises a two-part polyurethane or a moisture curable polyurethane, and the coating apparatus preferably further includes an indexing substrate positioned between the coating apparatus and the polyurethane source for carrying away any accumulated build-up of polyurethane which occurs during coating.

Accordingly, it is a feature of embodiments of the present invention to provide methods of making a printing blanket or sleeve in which one or more layers are formed from polyurethane which is cast by slot die coating, electrostatic or non-electrostatic spraying, or knife coating. Other features and advantages of the invention will be apparent from the following description, the accompanying drawings, and the appended claims.

### BRIEF DESCRIPTION OF THE DRAWINGS

FIG. 1A is a perspective view of a slot die apparatus used in one embodiment of a method of forming a printing blanket in accordance with the present invention;

FIG. 1B is a perspective view of a slot die apparatus used in a method of forming a printing sleeve in accordance with another embodiment of the present invention;

FIG. 2A is a perspective view of a spraying apparatus used in a method of forming a printing blanket in accordance with another embodiment of the present invention;

FIG. 2B is a perspective view of a spraying apparatus used in a method of forming a printing sleeve in accordance with another embodiment of the present invention;

FIG. 3A is a perspective view of a coating apparatus used in a method of forming a printing blanket in accordance with another embodiment of the present invention; and

FIG. 3B is a perspective view of a coating apparatus used in a method of forming a printing sleeve in accordance with another embodiment of the present invention; and

FIG. 3C is a perspective view of the coating apparatus of FIG. 3A further including a cleaning apparatus therein in accordance with another embodiment of the present invention;

FIG. 3D is a perspective view of the coating apparatus of FIG. 3B further including a cleaning apparatus therein in accordance with another embodiment of the present invention; and

FIG. 4 is a perspective view, with layers partially cut away, of a typical printing blanket formed in accordance with one or more embodiments of the present invention.

### DETAILED DESCRIPTION OF THE PREFERRED EMBODIMENTS

The methods and apparatus described herein to make a printing blanket from cast polyurethane layers may utilize two-part polyurethanes, moisture curable polyurethanes, UV or radiation curable polyurethanes, or cure-blocked or delayed-cure polyurethanes.

Suitable polyurethane casting compositions for use in the present invention are described in U.S. Pat. No. 3,211,701, the disclosure of which is hereby incorporated by reference. Such compositions comprise the reaction product of an isocyanate-terminated prepolymer with an organic chain extender or crosslinking agent (which may be a polyamine or a polyhydric alcohol) with a functionality of at least 2 and a molecular weight from 18 to 600. The isocyanate-terminated prepolymer is prepared from a hydroxyl-terminated polyester, polyether, or polybutadiene polyol or mixtures thereof having a molecular weight of 300 to 6000 and a functionality of at least 2 and optionally, a hydroxyl containing chain extending agent with a functionality of at least 2 and a molecular weight of 18 to 600, with an excess of organic diisocyanate.

The polyether polyols useful for the prepolymer are made by polymerization of cyclic ethers such as ethylene oxide, propylene oxide, butylene oxide, tetrahydrofuran, and the like. Such cyclic ethers can be used individually or as mixtures or in successive fashion when making a polyether.

Suitable polyesters containing hydroxyl groups include, e.g. reaction products of polyhydric (preferably dihydric) alcohols, optionally with the addition of trihydric alcohols, and polybasic (preferably dibasic) carboxylic acids. Instead of free polycarboxylic acids, the corresponding polycarboxylic acid anhydrides or corresponding polycarboxylic acid esters of lower alcohols or mixtures thereof may be used for preparing the polyesters. The polycarboxylic acids may be aliphatic, cycloaliphatic, aromatic, and/or heterocyclic and they may be substituted, e.g. by halogen atoms, and/or may be unsaturated. Exemplary compounds include succinic acid, adipic acid, sebacic acid, phthalic acid, isophthalic acid, trimellitic acid, phthalic acid anhydride, tetrahydrophthalic acid anhydride, hexahydrophthalic acid anhydride, tetrachlorophthalic acid anhydride, glutaric acid anhydride, maleic acid, maleic acid anhydride, dimeric and trimeric fatty acids such as oleic acid. Exemplary polyhydric alcohols include ethylene glycol, propylene glycol, butylene glycol, hexanediol, octanediol, neopentyl glycol, cyclohexane dimethanol, 2-methyl-1,3-propanediol, glycerol, trimethylolpropane, hexanetriol, butanetriol, trimethylolethane, pentaerythritol, mannitol, sorbitol, methyl glycoside, diethylene glycol, triethylene glycol, dipropylene glycol, polypropylene glycol, dibutylene glycol, polybutylene glycols, and the like. The polyesters may also contain a proportion of carboxyl end groups. Polyesters of lactones may also be used. The polyesters have at least 2 and generally from 2 to 8, preferably 2 or 3, hydroxyl groups.

Suitable polybutadiene polyols are Poly Bd polyols from Sartomer and liquid polybutadiene Krasol polyols from Kaucuk.

Suitable isocyanates for the prepolymers include aromatic or aliphatic diisocyanates and triisocyanates commonly known to those skilled in the art. Examples include 2,2′-, 2,4′-, or 4,4′-methylenediphenylene diisocyanate (MDI), polymeric MDIs, MDI variants, carbodiimide-modified MDIs, modified di- and polyisocyanates (urea-, biuret-, urethane-, isocyanurate-, allophanate-, carbodiimide-, or uretdione-modified, etc.), hydrogenated MDIs, 2,4 or 2,6-toluene diisocyanates or mixtures thereof, p-phenylene diisocyanate, TMXDI, isophorone diisocyanate, adducts of isophorone diisocyanate such as the urea, biuret trimer, dimer and allophanate, 4-diisocyanatobutane, 1,4-cyclohexanediisocyanate, hexamethylene diisocyanate,the adducts of hexamethylene diisocyanate such as biuret, trimer, dimer, allophanate and the like, and mixtures thereof.

Illustrative, but non-limiting examples of hydroxyl containing chain extenders or cross-linkers include ethylene glycol, diethylene glycol, triethylene glycol, propylene glycol, dipropylene glycol, tripropylene glycol, 1,3-propanediol, 2-methyl-1,3-propane diol, neopentyl glycol, 1,3- and 2,3-butylene glycol, 1,4-butanediol, 1,5-pentanediol, 1,6-hexanediol, 1,8-octanediol, 1,4-cyclohexanediol, 1,4-cyclohexanedimethanol, hydroquinone bis[2-hydroxyethyl ether], and the various bisphenols and their bis[hydroxyalkyl ether] derivatives, glycerin, trimethyol propane and ethoxylated derivatives thereof.

Suitable curing agents for the isocyanate-terminated prepolymers of the present invention include, for example, sterically hindered aromatic polyamines, sterically hindered aromatic diamines, diamines substituted with electron withdrawing groups and mixtures thereof. Examples of aromatic diamines which are rendered less active by electrical effects of ring substituents include 4,4′-methylene-bis(2-chloroaniline) (MOCA or MbOCA) and 4,4-methylene-bis(3-chloro-2,6-diethylaniline) (MCDEA).

These sterically hindered aromatic diamines have molecular weights of less than 500 and include, for example, 1-methyl-3,5-diethyl-2,4-diamino benzene, 1-methyl-3,5-diethyl-2,6-diamino benzene, 3,5-dimethylthio-2,4-toluene diamine, 3,5-dimethylthio-2,6-toluene diamine, 1,3,5-trimethyl-2,4-diamino benzene, 1,3,5-triethyl-2,4-diamino benzene, 3,5,3′,5′-tetraethyl-4,4′-diamino diphenylmethane, 3,5,3′,5′-tetraisopropyl-4,4′-diamino diphenylmethane, 3,5-diethyl-3′,5′-diisopropyl-4,4′-diamino diphenylmethane, 3,5-diethyl-5,5′-diisopropyl-4,4′-diamino diphenyl-methane, 1-methyl-2,6-diamino-3-isopropyl-benzene, trimethylene glycol di-p-amino-benzoate, and mixtures of the above diamines, such as, for example, mixtures of 1-methyl-3,5-diethyl-2,4-diamino benzene and 1-methyl-3,5-diethyl-2,6-diamino benzene in a weight ratio between about 50:50 to 85:15, preferably about 65:35 to 80:20. Some hindered amines are commercially available and sold as Baytec CUR W or Ethacure 100 (a mixture of 3,5-diethyl-2,4-toluenediamine and 3,5-diethyl-2,6-toluenediamine; Bayer Corp. or Albemarle Corporation) and Ethacure 300 from Albemarle Corporation (a mixture of 3,5-dimethylthio-2,4-toluenediamine and 3,5-diethyl-thio-2,6-toluenediamine). The difunctional and polyfunctional aromatic amine compounds may also exclusively or partly contain secondary amino groups such as 4,4′-di-(methylamino)-diphenylmethane, or 1-methyl-2-methylamino-4-amino-benzene.

Suitable prepolymers for the two-part polyurethanes of the present invention are commercially available from Chemtura (formerly Crompton Corp.), Sika Deutschland GmbH, ITWC, Bayer, and Dow.

The cure-blocked and/or delayed-cure polyurethanes are preferably derived from either blocked isocyanates or blocked or delayed action curatives, depending on the casting method employed. Where the polyurethanes are derived from blocked isocyanates, a prepolymer such as those described above for two-component systems is reacted with a blocking group such as methylethyl ketoxime, caprolactam or other active hydrogen-containing compound prior to adding a chain extender or crosslinking agent to the system. Curing is initiated only after the mixture is applied to a substrate and heat is supplied. In the presence of heat, the blocking group is released from the original isocyanate group, thus allowing the isocyanate group to react with other active hydrogen containing entities in the matrix.

Where the polyurethane is derived from blocked or delayed action curatives, such curatives may comprise a complex of methylene dianiline (MDA) and sodium chloride dispersed in dioctyl phthalate. The blocked or delayed action curative is added to a prepolymer such as those described above for a two component system (it replaces the chain extender or cross-linker in the two component cast system). Curing is initiated after the mixture is applied to a substrate and heat is supplied. At room temperature, this complex reacts very slowly with free isocyanate groups, but at elevated temperatures, the salt compound unblocks, releasing MDA which reacts rapidly with the free isocyanate present. Examples of suitable cure-blocked and/or delayed-cure polyurethanes include the MEKO and Caytur type systems from Chemtura.

Suitable moisture-cure polyurethanes for use in the present invention include urethane prepolymers which are isocyanate-capped polyols, such as polyesters, polyethers and polyester/polyols that do not contain any internal cross-linking agent (i.e., water cross-links the polymer and gives the desired physical properties). Typical prepolymers for moisture cured polyurethanes are the same as those described above for two component cast polyurethane systems, but normally the final free NCO content of the prepolymer for a moisture cured systems will be 5% or less while typical prepolymers used in two component cast systems range from greater than 2% up to about 12%. Preferred moisture curable polyurethanes for use are commercially available from Bayer, Futura, Sika and others.

A typical UV or radiation-curable polyurethane system contains an oligomer, which may or may not contain reactive functional groups (such as double bonds), a crosslinking agent, a reactive diluent for viscosity control, and a photosensitizer or photoinitiator. By selecting an oligomer which contains at least two points of reactive unsaturation, or a reactive diluent which contains at least two points of reactive unsaturation, a crosslinking agent may be eliminated. Control over the properties of the cured systems can be exercised via the structure of the oligomer backbone, including such factors as degree of chain-branching, types of functional groups, number and types of unsaturated bonds, molecular weight, etc.; functionality and level of crosslinking agents; nature and level of reactive diluent; kind and level of the sensitizer or photoinitiator; and the like. An exemplary oligomer is an unsaturated urethane oligomer obtained by reacting an isocyanate-functional prepolymer with unsaturated compounds containing an isocyanate-reactive active hydrogen group. The unsaturated urethane oligomers are typically the reaction product of at least one organic isocyanate compound having at least two isocyanate groups; at least one polyether or polyester polyol with a functionality of at least 2 (similar to those described above); and at least one unsaturated addition-polymerizable monomeric compound having a single isocyanate-reactive active hydrogen group such as hydroxyl ethyl(propyl)-(methyl)acrylate. Before any polymerization can occur, free radicals must first be produced via the photoinitiator. The production of free radicals by the photoinitiator is a wave length function of the actinic radiation. Once the radicals are formed, propagation of polymer growth rapidly advances through chain reaction. Suitable UV or radiation curable polyurethanes are available from companies such as Sartomer, Radcure and others.

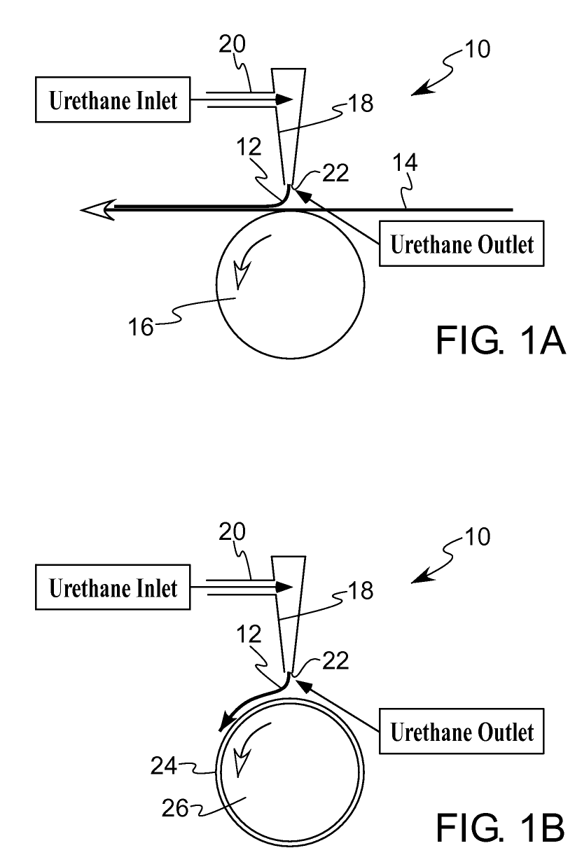

Referring now to FIG. 1A, one embodiment of the present invention is illustrated in which a slot die apparatus 10 is used to apply polyurethane in the form of a flowable coating 12 onto a moving substrate web 14 which is supported by a coating or back up roll 16. The substrate web 14 preferably comprises one or more layers of a woven or non-woven fabric, or a sheet or film of a polymeric material. As polyurethane is pumped from inlet 20 into the interior of the die, it is dispensed through slot outlet 22 onto the web. The slot die is hollow and includes a blade 18 or other device which controls the thickness of the polyurethane as it exits the slot die. For example, blade 18 may be positioned to apply a predetermined thickness of polyurethane onto the web. The web is then transported downstream from the coating apparatus (not shown) where curing is initiated. In this embodiment, the polyurethane is preferably a UV or radiation curable, or cure-blocked or delayed-cure polyurethane in which curing is initiated by exposure to a curing source such as UV light, electron beam, or heat. After curing, the web may optionally be transported back to the slot die coating apparatus and the method may be repeated to apply the desired number of subsequent polyurethane layers to achieve a desired thickness.

In an alternative embodiment illustrated in FIG. 1B, a slot die apparatus 10 is shown which is used to apply a polyurethane coating onto printing blanket sleeve 24 which is provided on a rotary support or mandrel 26. The sleeve 24 is preferably comprised of a nickel or fiberglass base. Alternatively, the polyurethane may be applied directly to the mandrel to form a base layer prior to coating with subsequent polyurethane layers. In this instance, a release coating should be applied to the mandrel prior to coating with polyurethane.

As described above, after the polyurethane is coated onto the sleeve, curing is initiated at a location downstream from the coating apparatus. For example, curing may be initiated on the side of the cylinder which is opposite the slot die and isolated from the point of coating. After the sleeve is cured, it may then be rotated back to the slot die apparatus for application of further layers.

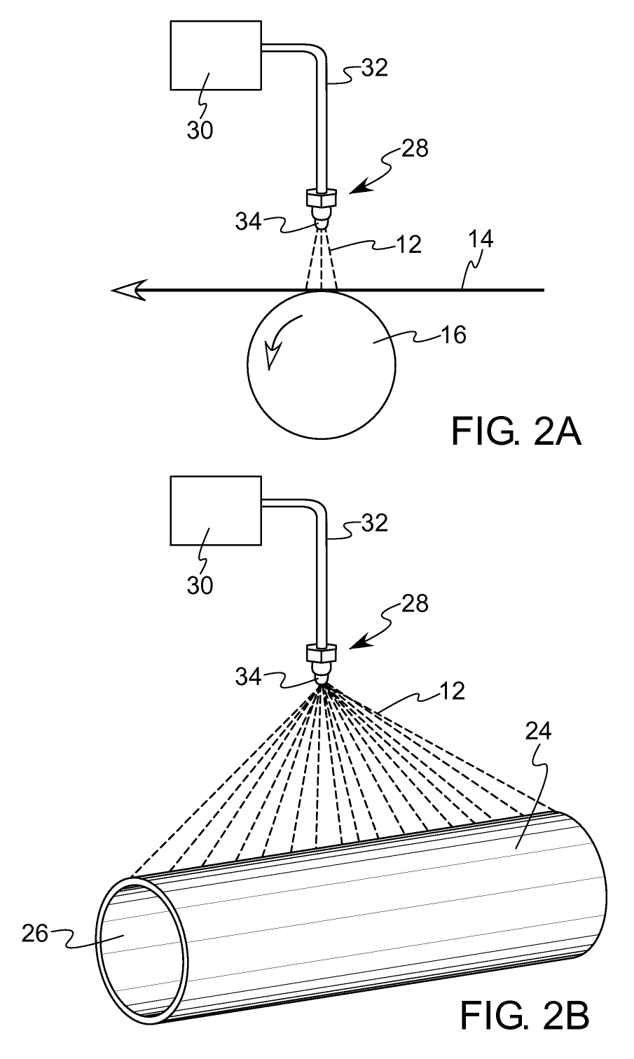

Referring now to FIGS. 2A and 2B, another embodiment of the method of the present invention is illustrated in which polyurethane 12 is electrostatically or non-electrostatically sprayed over substantially the entire surface of a moving web 14 or rotating sleeve 24 using a spraying apparatus 28. An example of a desirable non-electrostatic spraying process is disclosed in U.S. Pat. Nos. 5,656,677, 5,028,006, and 6,071,619, which are incorporated herein by reference. The process described in those patents is directed to a method of obtaining a light stable polyurethane elastomer in which a homogeneous polyurethane layer is sprayed onto the surface of an open mold in a single pass. The polyurethane is relatively viscous and gels quickly in order to prevent the run-off of the material on the mold surface under the influence of gravity while the viscosity of the polyurethane is sufficiently low in the initial state to obtain a homogeneous spreading over the mold surface and also to prevent clogging of the spray pistol. In the process of the present invention, it is important that the gelation time is not too quick so that a homogeneous thickness can be obtained.

An example of a suitable electrostatic spraying process is described in U.S. Publication Nos. 2003/0033948 and 2003/0116044, which are incorporated herein by reference. This method may be used in embodiments where solvent-free polyurethane systems are used, and is designed to produce one or more layers of solvated elastomer on a printing blanket or sleeve such that the boundary within one layer of the sleeve comprised of two components is a gradient or such that the boundary between two layers is a gradient.

In this embodiment, the polyurethane preferably comprises a two-part polyurethane or a moisture curable polyurethane. Such polyurethanes are preferred because cure initiating equipment is not required. However, it should be appreciated that UV or radiation curable and cure-blocked or delayed-cure polyurethanes can also be used in such a system where the substrate with the polyurethane coating is transported downstream or rotated away from the spraying apparatus where cure is initiated by exposure to UV light, electron beam, or heat.

As shown in FIGS. 2A and 2B, the polyurethane is preferably supplied from a tank 30. Where the polyurethane comprises a two-part polyurethane, the polyurethane may be mixed prior to being placed in the tank 30 or may be supplied directly from the mixing unit. The polyurethane is preferably fed from tank 30 through a line 32 which supplies the polyurethane to a spray nozzle 34 for spraying directly onto substantially the entire width of the outer surface of the web 14 or sleeve 24. Where the polyurethane is sprayed onto the sleeve, the mandrel is preferably rotated during spraying to apply an even coat. After substantially the entire surface has been coated and allowed to cure, subsequent layers may be applied by repeating the method.

It should be appreciated that the surface area within the spray nozzle is sufficiently small and the polyurethane is under sufficient pressure such that the polyurethane is nearly completely refreshed along the inner surfaces of the spray nozzle. Accordingly, build-up of cured or partially cured polyurethane is not a significant issue in this method, and prevention of premature exposure to moisture is not as difficult as in prior art methods.

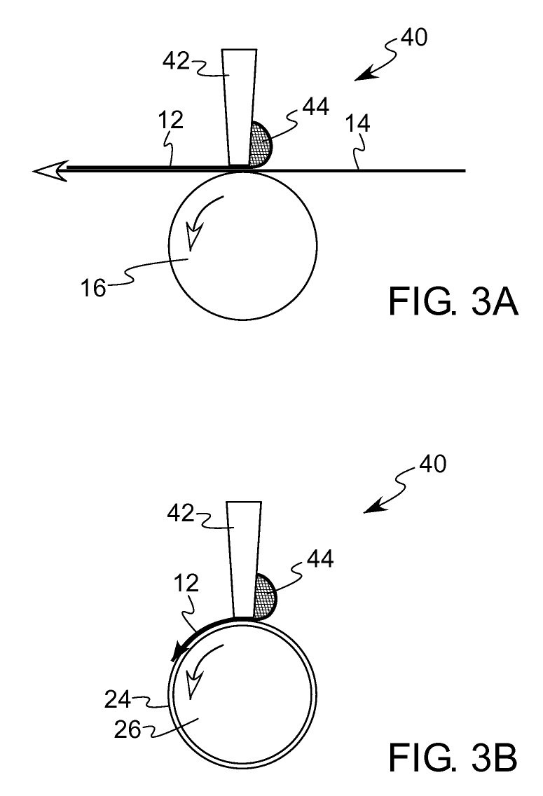

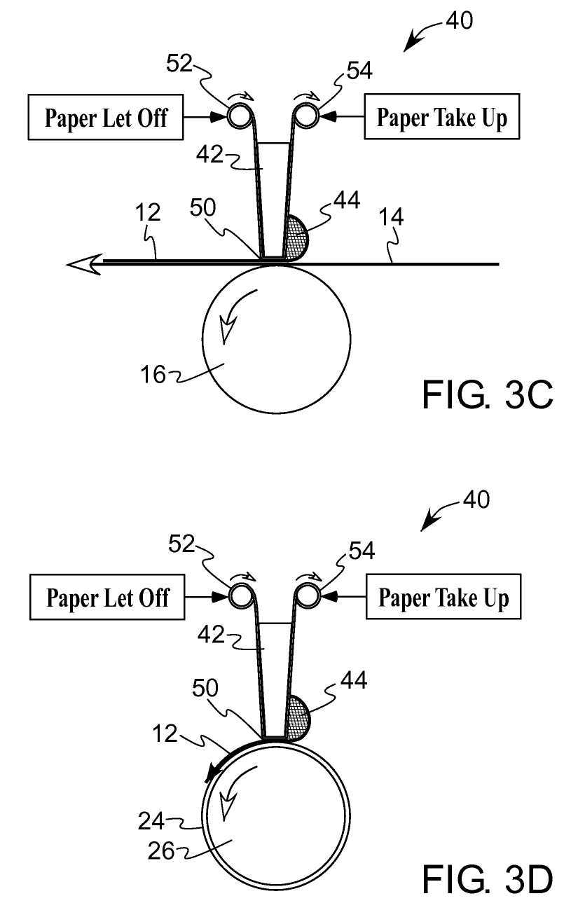

FIGS. 3A and 3B illustrate additional embodiments of the invention in which the polyurethane is knife-coated onto a substrate web or base sleeve. The knife coating apparatus 40 includes a blade 42 which functions to control the thickness of the polyurethane, and to spread and evenly coat the polyurethane as it is metered from a rolling bank 44. The knife coating apparatus may be used to coat polyurethane onto a moving substrate web 14 as shown in FIG. 3A, or it may be used to coat polyurethane onto a base sleeve 24 as shown in FIG. 3B. In this embodiment, the polyurethane is preferably a UV or radiation curable polyurethane or cure-blocked or delayed-cure polyurethane, such that it does not cure until exposed to a source such as UV light, electron beam, or heat, which source is located downstream and isolated from the coating apparatus.

FIGS. 3C and 3D illustrate additional embodiments of this method in which the polyurethane is knife coated onto a substrate web 14 or base sleeve 24, and the knife coating apparatus 40 further includes a cleaning apparatus comprising an indexing substrate 50 which is positioned between the coating apparatus and the polyurethane source or rolling bank 44 such that the substrate 50 functions to carry away any build-up of cured or partially cured polyurethane which occurs during coating. The cleaning apparatus is preferably used with the knife coating apparatus when the polyurethane comprises two-part or moisture curable polyurethanes, which tend to build-up on the knife coating apparatus due to their short pot life. By carrying away any build-up of cured or partially cured polyurethane which may accumulate during casting, the flow of polyurethane is prevented from being blocked. Further, with the use of the indexing paper, the two-part or moisture curable polyurethanes can be used without the need for special curing equipment. However, it should be appreciated that UV curable, radiation curable, and cure-blocked or delayed-cure polyurethanes can also be used in such a system where the substrate with the polyurethane coating is transported downstream or rotated away from the spraying apparatus where cure is initiated by exposure to UV light, electron beam, or heat.

The indexing paper is supplied via rotating rolls 52, 54 and may comprise any paper which has sufficient strength to resist tearing/breaking and which is capable of performing the cleaning function. While indexing paper is preferred for use in the present invention, it should be appreciated that substrates such as plastic films or fabrics may also be used to carry away the partially cured or cured urethane.

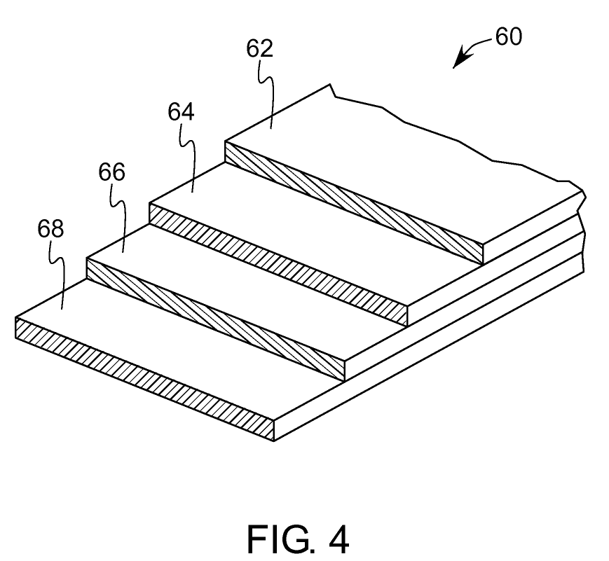

FIG. 4 illustrates a perspective view of one embodiment of the printing blanket construction 60 of the present invention. The printing blanket preferably includes at least a printing surface layer 62, a reinforcing layer 64, a compressible layer 66, and a base layer 68. It should be appreciated that while these layers may all be formed from repeated castings of polyurethane, it is also possible to form one or more of the layers from materials which are typically used to form such layers in a blanket or sleeve. For example, the base layer may comprise a rubber or fabric layer.

Having described the invention in detail and by reference to preferred embodiments thereof, it will be apparent that modifications and variations are possible without departing from the scope of the invention.

What is claimed is:

1. A method of making a printing blanket including a cast polyurethane layer comprising:
providing a slot die including an inlet, an outlet, and a device thereon for controlling the thickness of said cast polyurethane layer;
introducing uncured polyurethane in the form of a flowable material into said inlet of said slot die;
causing said polyurethane to exit said outlet of said slot die and deposit over substantially the entire surface of a moving substrate web or rotating sleeve to form a layer thereon; and
transporting said polyurethane layer on said substrate or sleeve downstream from said slot die and curing said polyurethane layer.

2. The method of claim 1 wherein said polyurethane layer is formed on said substrate or sleeve in a single pass.

3. The method of claim 1 wherein said uncured polyurethane comprises a UV curable polyurethane, a radiation curable polyurethane, cure-blocked polyurethane, or a delayed-cure polyurethane.

4. The method of claim 1 wherein curing is initiated by exposure to a curing source comprising UV light, electron beam, or heat.

5. The method of claim 1 wherein said curing source is isolated from said slot die such that said polyurethane is not exposed to said curing source as it exits said slot die.

6. The method of claim 1 wherein said polyurethane is deposited onto a substrate web and said substrate web comprises the base layer of a printing blanket construction.

7. The method of claim 6 wherein said substrate web comprises a woven or non-woven fabric, rubber, or a polymeric material.

8. The method of claim 1 wherein said polyurethane is deposited onto a sleeve and said sleeve is supported on a cylindrical mandrel.

9. The method of claim 8 wherein said mandrel is rotated such that said polyurethane is applied to substantially the entire surface of said sleeve to form a seamless layer of material.

10. The method of claim 1 including applying one or more additional polyurethane layers to said moving substrate or rotating sleeve by depositing one or more additional polyurethane layers from said slot die onto said substrate or sleeve.

11. A printing blanket construction formed by the method of claim 10 comprising a printing surface layer, a reinforcing layer, a compressible layer, and a base layer.

12. A method of making a printing blanket or sleeve including a cast polyurethane layer comprising:
providing a moving substrate web or rotating sleeve;
providing a source of uncured polyurethane in liquid form;
electrostatically or non-electrostatically spraying said polyurethane from said source over substantially the entire surface of said moving substrate or rotating sleeve to form a layer thereon; and
transporting said polyurethane layer on said substrate or sleeve downstream from the area of spraying and curing said polyurethane layer.

13. The method of claim 12 wherein said polyurethane is sprayed on said substrate or sleeve in a single pass.

14. The method of claim 12 wherein said polyurethane is sprayed through a spray nozzle onto said substrate or sleeve.

15. The method of claim 12 wherein said polyurethane comprises a two-part polyurethane or a moisture curable polyurethane.

16. The method of claim 12 including applying one or more additional polyurethane layers to said moving substrate or rotating sleeve by spraying one or more additional polyurethane layers from said source onto said substrate or sleeve.

17. A printing blanket construction formed by the method of claim 16 comprising a printing surface layer, a reinforcing layer, a compressible layer, and a base layer.

18. A method of making a printing blanket or sleeve including a cast polyurethane layer comprising:
providing uncured polyurethane in flowable form from a source;
coating said polyurethane onto a moving substrate web or rotating sleeve using a coating apparatus comprising a knife blade to control the thickness of the applied coating of polyurethane; and
transporting said polyurethane coated substrate or sleeve downstream from said coating apparatus and curing said polyurethane.

19. The method of claim 18 wherein said polyurethane layer is formed on said substrate or sleeve in a single pass.

20. The method of claim 18 wherein said polyurethane comprises a UV curable polyurethane, a radiation curable polyurethane, a cure-blocked polyurethane, or a delayed-cure polyurethane.

21. The method of claim 18 wherein said curing is initiated by a curing source comprising UV light, electron beam or heat.

22. The method of claim 18 wherein said curing source is isolated from said coating apparatus such that said uncured polyurethane is not exposed to said curing source.

23. The method of claim 18 wherein said polyurethane source comprises a rolling bank of uncured polyurethane.

24. The method of claim 18 wherein said coating apparatus includes a cleaning apparatus comprising an indexing substrate positioned between said coating apparatus and said polyurethane source for carrying away accumulated build-up of polyurethane during coating.

25. The method of claim 24 wherein said polyurethane comprises a two-part polyurethane or a moisture curable polyurethane.

26. The method of claim 18 including applying one or more additional polyurethane layers to said moving substrate or rotating sleeve by coating one or more additional polyurethane layers from said coating apparatus onto said substrate or sleeve.

27. A printing blanket construction formed by the method of claim 26 comprising a printing surface layer, a reinforcing layer, a compressible layer, and a base layer.
